(19) United States
(12) Patent Application Publication
(10) Pub. No.: US 2025/0027010 A1
(43) Pub. Date: Jan. 23, 2025

(54) FABRIC CONDITIONING METHOD

(71) Applicant: Conopco, Inc., d/b/a UNILEVER, Englewood Cliffs, NJ (US)

(72) Inventors: Martin Charles Crossman, Eastham (GB); David Richard Arthur MEALING, Heswall, Wirral (GB)

(73) Assignee: Conopco, Inc., d/b/a UNILEVER, Englewood Cliffs, NJ (US)

(21) Appl. No.: 18/714,919

(22) PCT Filed: Nov. 29, 2022
(86) PCT No.: PCT/EP2022/083728

§ 371 Date: May 30, 2024

(30) Foreign Application Priority Data
Dec. 2, 2021 (EP) 21212021.6

(51) Int. Cl. C11D 3/00; C11D 3/20; C11D 3/30; C11D 3/50

(52) U.S. Cl. CPC C11D 3/0015; C11D 3/2093; C11D 3/30; C11D 3/505

(57) ABSTRACT

A method of treating polyester during the laundry process, wherein a fabric conditioner composition comprising: a) 2 to 30 wt. % quaternary ammonium compound; and b) natural oil; is added to the rinse stage of the laundry process.

### FIELD OF THE INVENTION

The present invention is in the field of fabric conditioners, in particular methods of treating polyesters with fabric conditioners.

### BACKGROUND OF THE INVENTION

Fabric conditioners traditionally provide softening to fabrics by the use of quaternary ammonium compounds. These quaternary ammonium containing compositions were routinely designed with cotton fabrics in mind, since cotton is traditionally the most common fabric in the consumer's laundry basket. However, fashion and textiles are changing and polyester is quickly taking over as the most common fabric. Quaternary ammonium compounds behave differently on polyesters compared to cotton fabrics. As such, there is a need for fabric conditioner compositions which are optimized for polyesters.

One particular issue is the speed of drying. There is a need for compositions designed for polyester fabrics which improve the drying speed of the fabric.

### SUMMARY OF THE INVENTION

It has been found that by incorporating a natural oil into a fabric conditioner, a method of treating polyesters can be provided, resulting in a faster drying time of the polyester.

Accordingly in one aspect of the present invention is provided a method of treating polyester during the laundry process, wherein a fabric conditioner composition comprising:
a 2 to 30 wt. % quaternary ammonium compound; and
b Natural oil;

is added to the rinse stage of the laundry process.

The invention further relates to the use of the method as described herein, to improve the speed of polyester drying time following the application of a fabric conditioner.

### DETAILED DESCRIPTION OF THE INVENTION

These and other aspects, features and advantages will become apparent to those of ordinary skill in the art from a reading of the following detailed description and the appended claims. For the avoidance of doubt, any feature of one aspect of the present invention may be utilised in any other aspect of the invention. The word “comprising” is intended to mean “including” but not necessarily “consisting of” or “composed of.” In other words, the listed steps or options need not be exhaustive. It is noted that the examples given in the description below are intended to clarify the invention and are not intended to limit the invention to those examples per se. Similarly, all percentages are weight/weight percentages unless otherwise indicated. Except in the operating and comparative examples, or where otherwise explicitly indicated, all numbers in this description indicating amounts of material or conditions of reaction, physical properties of materials and/or use are to be understood as modified by the word “about”. Numerical ranges expressed in the format “from x to y” are understood to include x and y. When for a specific feature multiple preferred ranges are described in the format “from x to y”, it is understood that all ranges combining the different endpoints are also contemplated.

### Fabric Softening Active

The fabric conditioners for use in the method described herein comprise quaternary ammonium compounds (QAC).

The QAC preferably comprises at least one chain derived from fatty acids, more preferably at least two chains derived from a fatty acid. Generally fatty acids are defined as aliphatic monocarboxylic acids having a chain of 4 to 28 carbons. Fatty acids may be derived from various sources such as tallow or plant sources. Preferably the fatty acid chains are derived from plants. Preferably the fatty acid chains of the QAC comprise from 10 to 50 wt. % of saturated C18 chains and from 5 to 40 wt. % of monounsaturated C18 chains by weight of total fatty acid chains. In a further preferred embodiment, the fatty acid chains of the QAC comprise from 20 to 40 wt. %, preferably from 25 to 35 wt. % of saturated C18 chains and from 10 to 35 wt. %, preferably from 15 to 30 wt. % of monounsaturated C18 chains, by weight of total fatty acid chains.

The preferred quaternary ammonium fabric softening actives for use in compositions of the present invention are so called “ester quats” or ester linked quaternary ammonium compounds. Particularly preferred materials are the ester-linked triethanolamine (TEA) quaternary ammonium compounds comprising a mixture of mono-, di- and tri-ester linked components. Typically, TEA-based fabric softening compounds comprise a mixture of mono, di- and tri ester forms of the compound where the di-ester linked component comprises no more than 70 wt. % of the fabric softening compound, preferably no more than 60 wt. % e.g., no more than 55%, or even no more that 45% of the fabric softening compound and at least 10 wt. % of the monoester linked component.

A first group of quaternary ammonium compounds (QACs) suitable for use in the present invention is represented by formula (I):

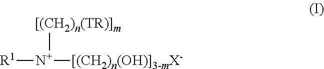

wherein each R is independently selected from a C5 to C35 alkyl or alkenyl group; R¹ represents a C1 to C4 alkyl, C2 to C4 alkenyl or a C1 to C4 hydroxyalkyl group; T may be either O—CO. (i.e. an ester group bound to R via its carbon atom), or may alternatively be CO—O (i.e. an ester group bound to R via its oxygen atom); n is a number selected from 1 to 4; m is a number selected from 1, 2, or 3; and X− is an anionic counter-ion, such as a halide or alkyl sulphate, e.g. chloride or methylsulfate. Di-esters variants of formula I (i.e., m=2) are preferred and typically have mono- and tri-ester analogues associated with them. Such materials are particularly suitable for use in the present invention.

Suitable actives include soft quaternary ammonium actives such as Stepantex VT90, Rewoquat WE18 (ex-Evonik) and Tetranyl L1/90N, Tetranyl L190 SP and Tetranyl L190 S (all ex-Kao).

Also suitable are actives rich in the di-esters of triethanolammonium methylsulfate, otherwise referred to as “TEA ester quats”.

Commercial examples include Preapagen™ TQL (ex-Clariant), and Tetranyl™ AHT-1 (ex-Kao), (both di-[hardened tallow ester] of triethanolammonium methylsulfate), AT-1 (di-[tallow ester] of triethanolammonium methylsulfate), and L5/90 (di-[palm ester] of triethanolammonium methylsulfate), (both ex-Kao), and Rewoquat™ WE15 (a di-ester of triethanolammonium methylsulfate having fatty acyl residues deriving from C10-C20 and C16-C18 unsaturated fatty acids) (ex-Evonik).

A second group of QACs suitable for use in the invention is represented by formula (II):

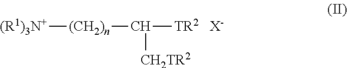

wherein each R¹ group is independently selected from C1 to C4 alkyl, hydroxyalkyl or C2 to C4 alkenyl groups; and wherein each R² group is independently selected from C8 to C28 alkyl or alkenyl groups; and wherein n, T, and X− are as defined above.

Preferred materials of this second group include 1,2 bis[tallowoyloxy]-3-trimethylammonium propane chloride, 1,2 bis[hardened tallowoyloxy]-3-trimethylammonium propane chloride, 1,2-bis[oleoyloxy]-3-trimethylammonium propane chloride, and 1,2 bis[stearoyloxy]-3-trimethylammonium propane chloride. Such materials are described in U.S. Pat. No. 4,137,180 (Lever Brothers). Preferably, these materials also comprise an amount of the corresponding mono-ester.

A third group of QACs suitable for use in the invention is represented by formula (III):

(R¹)₂+N⁺—[(CH₂)ₙT-R²]₂X⁻ (III)

wherein each R¹ group is independently selected from C1 to C4 alkyl, or C2 to C4 alkenyl groups; and wherein each R² group is independently selected from C8 to C28 alkyl or alkenyl groups; and n, T, and X− are as defined above. Preferred materials of this third group include bis(2-tallowoyloxyethyl)dimethyl ammonium chloride, partially hardened and hardened versions thereof.

A particular example of the fourth group of QACs is represented the by the formula (IV):

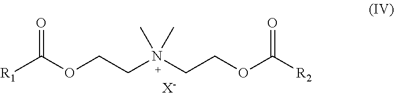

A fourth group of QACs suitable for use in the invention are represented by formula (V)

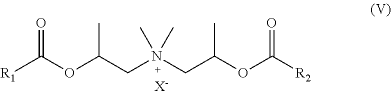

R₁ and R₂ are independently selected from C10 to C22 alkyl or alkenyl groups, preferably C14 to C20 alkyl or alkenyl groups. X− is as defined above.

The iodine value of the quaternary ammonium fabric conditioning material is preferably from 0 to 80, more preferably from 0 to 60, and most preferably from 0 to 45. The iodine value may be chosen as appropriate. Essentially saturated material having an iodine value of from 0 to 5, preferably from 0 to 1 may be used in the compositions of the invention. Such materials are known as “hardened” quaternary ammonium compounds.

A further preferred range of iodine values is from 20 to 60, preferably 25 to 50, more preferably from 30 to 45. A material of this type is a “soft” triethanolamine quaternary ammonium compound, preferably triethanolamine di-alkylester methylsulfate. Such ester-linked triethanolamine quaternary ammonium compounds comprise unsaturated fatty chains. If there is a mixture of quaternary ammonium materials present in the composition, the iodine value, referred to above, represents the mean iodine value of the parent fatty acyl compounds or fatty acids of all the quaternary ammonium materials present. Likewise, if there are any saturated quaternary ammonium materials present in the composition, the iodine value represents the mean iodine value of the parent acyl compounds of fatty acids of all of the quaternary ammonium materials present.

Iodine value as used in the context of the present invention refers to, the fatty acid used to produce the QAC, the measurement of the degree of unsaturation present in a material by a method of nmr spectroscopy as described in Anal. Chem., 34, 1136 (1962) Johnson and Shoolery.

A further type of softening compound may be a non-ester quaternary ammonium material represented by formula (VI):

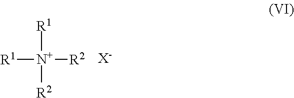

wherein each R¹ group is independently selected from C1 to C4 alkyl, hydroxyalkyl or C2 to C4 alkenyl groups; R² group is independently selected from C8 to C28 alkyl or alkenyl groups, and X− is as defined above.

Preferably the fabric conditioners of the present invention comprise more than 1 wt. % fabric softening active, more preferably more than 2 wt. % fabric softening active, most preferably more than 3 wt. % fabric softening active by weight of the composition. Preferably the fabric conditioners of the present invention comprise less than 40 wt. % fabric softening active, more preferably less than 30 wt. % fabric softening active, most preferably less than 25 wt. % fabric softening active by weight of the composition. Suitably the fabric conditioners comprise 1 to 40 wt. % fabric softening active, preferably 2 to 30 wt. % fabric softening active and more preferably 3 to 25 wt. % fabric softening active by weight of the composition.

The fabric conditioners described herein may be so called dilute at home fabric conditioners. These are fabric conditioner compositions which are sold in a concentrated form. The consumer then dilutes the composition at home prior to use of the composition. If the fabric conditioner is a concentrated dilute at home composition, preferably the fabric conditioners comprise more than 10 wt. % fabric softening active, more preferably more than 15 wt. % fabric softening active, most preferably more than 20 wt. % fabric softening active by weight of the composition. Preferably the fabric conditioners of the present invention comprise less than 50 wt. % fabric softening active, more preferably less than 45 wt. % fabric softening active, most preferably less than 40 wt. % fabric softening active by weight of the composition. Suitably concentrated fabric conditioners for dilute at home comprise 10 to 50 wt. % fabric softening active, preferably 15 to 45 wt. % fabric softening active and more preferably 20 to 40 wt. % fabric softening active by weight of the composition.

### Natural Oil

The compositions for use in the method described herein comprise natural oils. Natural oils comprise plant oils or the esterified fatty acids of plant oils. Natural oils exclude mineral oils derived from petroleum. Preferably the natural oil is a liquid or soft solid.

Plant oils include vegetable (e.g., olive oil), nut and seed oils. Plant oils also include microbial oils, which are oils produced by microbes or other organisms, including algal oils and including genetically modified or engineered microbes that produce oils. Plant oils preferably include triglycerides, free fatty acids, or a combination of both.

Preferably the natural oil comprises seed oils or the esterified fatty acids thereof. Seed oils include almond, argan, babassu, borage, camelina, canola®, castor, chia, cherry, coconut, corn, cotton, coffee, Cuphea viscosissima, flax (linseed), grape, hemp, hepar, jatropha, jojoba, Lesquerella fendleri oil, Moringa Oleifera oil, macadamia, mango, mustard, neem, oil palm, Perilla, rapeseed, safflower, sesame, shea, stillingia, soybean, sunflower, tonka bean, tung.

The natural oil may comprise a triglyceride or mixtures of triglycerides with varying degrees of alkyl chain length and unsaturation. Each triglyceride comprises one or two or more, preferably three fatty acids, bonded by a glycerol bridge.

Preferably the natural oil comprises an ester oil. Ester oils are the esterified fatty acids of any of the above oils. The glycerides (of the above oils) are first hydrolysed to release fatty acids from the glycerol moiety, and then the fatty acids are then reacted with alcohols (mono-, di-, tri-, tetra, etc.) to form an ester oil. Preferably the natural oil comprises esterified fatty acids of seed oils.

Preferably, the ester oil is a polyol ester (i.e., more than one alcohol group is reacted to form the polyol ester). Preferably the polyol ester is formed by esterification of a polyol (i.e., reacting a molecule comprising more than one alcohol group with acids). Preferably the polyol ester comprises at least two ester linkages. Preferably the polyol ester comprises no hydroxyl groups. Preferably the ester oil is a pentaerythritol e.g., a pentaerythritol tetraisostearate. Exemplary structures of the compound are (VII) and (VIII) below:

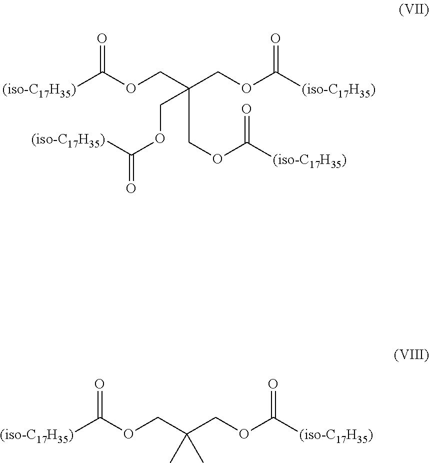

Preferably the ester oil is saturated.

Preferably, the ester oils are esters containing straight or branched, saturated or unsaturated carboxylic acids.

Suitable ester oils are the fatty ester of a mono or polyhydric alcohol having from 1 to about 24 carbon atoms in the hydrocarbon chain and mono or polycarboxylic acids having from 1 to about 24 carbon atoms in the hydrocarbon chain with the proviso that the total number of carbon atoms in the ester oil is equal to or greater than 16 and that at least one of the hydrocarbon radicals in the ester oil has 12 or more carbon atoms.

Preferably the viscosity of the natural oil is from 2 mPa·s to 400 mPa·s at a temperature of 25 C, more preferably a viscosity from 2 to 150 mPa·s, most preferably a viscosity from 10 to 100 mPa·s.

Preferably the refractive index of the natural oil is from 1.445 to 1.490, more preferred from 1.460 to 1.485.

The natural oil may be characterized by the percentage modern carbon in the oil. The percentage modern carbon (pMC) level is based on measuring the level of radiocarbon (C14) which is generated in the upper atmosphere from where it diffuses, providing a general background level in the air. The background level in the air represent 100% modern carbon. The level of C14, once captured (e.g. by biomass) decreases over time, in such a way that the amount of C14 is essentially depleted after 45,000 years. Hence the C14 level of fossil-based carbons, as used in the conventional petrochemical industry is virtually zero.

A pMC value of 100% would indicate that 100% of the carbon came from plants or animal by-products (biomass) living in the natural environment (or as captured from the air) and a value of 0% would mean that all of the carbon was derived from petrochemicals, coal and other fossil sources. A value between 0-100% would indicate a mixture. The higher the value, the greater the proportion of naturally sourced components in the oil.

The pMC level can be determined using the % Biobased Carbon Content ASTM D6866-20 Method B, using a National Institute of Standards and Technology (NIST) modern reference standard (SRM 4990C). Such measurements are known in the art are performed commercially, such as by Beta Analytic Inc. (USA). The technique to measure the C14 carbon level is known since decades and most known from carbon-dating archaeological organic findings.

Natural oils preferably comprise 50 to 100 percent modern carbon, more preferably 80 to 100 percent modern carbon and most preferably 95 to 100 percent modern carbon.

The natural oil of the current invention may be in the form of a free oil or an emulsion. The natural oil may be encapsulated. Suitable encapsulating materials, may comprise, but are not limited to; aminoplasts, proteins, polyurethanes, polyacrylates, polymethacrylates, polysaccharides, polyamides, polyolefins, gums, silicones, lipids, modified cellulose, polyphosphate, polystyrene, polyesters or combinations thereof. Particularly preferred materials are aminoplast microcapsules, such as melamine formaldehyde or urea formaldehyde microcapsules. Suitable microcapsules are disclosed in US 2003215417

In one aspect of the present invention, the microcapsules shell maybe coated with polymer to enhance the ability of the microcapsule to adhere to fabric, as described in U.S. Pat. Nos. 7,125,835; 7,196,049; and 7,119,057

The compositions described herein preferably comprise amount 0.25 wt. % to 15 wt. % natural oil, by weight of the composition, preferably 0.25 to 10 wt. %, more preferably 0.5 to 7 wt. % and most preferably 0.5 to 5 wt. % natural oil.

### Perfumes

The fabric conditioners for us in the present invention preferably comprise 0.05 to 15 wt. % free perfume, more preferably 0.1 to 10 wt. % free perfume.

Useful perfume components may include materials of both natural and synthetic origin. They include single compounds and mixtures. Specific examples of such components may be found in the current literature, e.g., in Fenaroli's Handbook of Flavor Ingredients, 1975, CRC Press; Synthetic Food Adjuncts, 1947 by M. B. Jacobs, edited by Van Nostrand; or Perfume and Flavor Chemicals by S. Arctander 1969, Montclair, N.J. (USA). These substances are well known to the person skilled in the art of perfuming, flavouring, and/or aromatizing consumer products.

Particularly preferred perfume components are blooming perfume components and substantive perfume components. Blooming perfume components are defined by a boiling point less than 250° C. and a Log P or greater than 2.5. Substantive perfume components are defined by a boiling point greater than 250° C. and a Log P greater than 2.5. Boiling point is measured at standard pressure (760 mm Hg). Preferably a perfume composition will comprise a mixture of blooming and substantive perfume components. The perfume composition may comprise other perfume components.

It is commonplace for a plurality of perfume components to be present in a free oil perfume composition. In the compositions for use in the present invention it is envisaged that there will be three or more, preferably four or more, more preferably five or more, most preferably six or more different perfume components. An upper limit of 300 perfume components may be applied.

The fabric conditioner compositions of the present invention preferably comprise 0.05 to 10 wt. % perfume microcapsules, more preferably 0.1 to 8 wt. % perfume microcapsules. The weight of microcapsules is of the material as supplied.

When perfume components are encapsulated, suitable encapsulating materials, may comprise, but are not limited to; aminoplasts, proteins, polyurethanes, polyacrylates, polymethacrylates, polysaccharides, polyamides, polyolefins, gums, silicones, lipids, modified cellulose, polyphosphate, polystyrene, polyesters or combinations thereof. Particularly preferred materials are aminoplast microcapsules, such as melamine formaldehyde or urea formaldehyde microcapsules.

Perfume microcapsules of the present invention can be friable microcapsules and/or moisture activated microcapsules. By friable, it is meant that the perfume microcapsule will rupture when a force is exerted. By moisture activated, it is meant that the perfume is released in the presence of water. The fabric conditioners of the present invention preferably comprise friable microcapsules. Moisture activated microcapsules may additionally be present. Examples of a microcapsules which can be friable include aminoplast microcapsules.

Perfume components contained in a microcapsule may comprise odiferous materials and/or pro-fragrance materials.

Particularly preferred perfume components contained in a microcapsule as described above. The microcapsules may comprise perfume components and a carrier for the perfume ingredients, such as zeolites or cyclodextrins.

### Co-Softeners

The fabric conditioners for use in the method of the present invention preferably comprise co-softeners. When employed, they are typically present at from 0.1 to 20% and particularly at from 0.5 to 10%, based on the total weight of the composition. Preferred co-softeners include fatty esters, and fatty N-oxides. Fatty esters that may be employed include fatty monoesters, such as glycerol monostearate, fatty sugar esters, such as those disclosed WO 01/46361 (Unilever).

The compositions of the present invention may comprise a fatty complexing agent.

Especially suitable fatty complexing agents include fatty alcohols and fatty acids. Of these, fatty alcohols are most preferred.

Without being bound by theory it is believed that the fatty complexing material improves the viscosity profile of the composition by complexing with mono-ester component of the fabric conditioner material thereby providing a composition which has relatively higher levels of di-ester and tri-ester linked components. The di-ester and tri-ester linked components are more stable and do not affect initial viscosity as detrimentally as the mono-ester component.

It is also believed that the higher levels of mono-ester linked component present in compositions comprising quaternary ammonium materials based on TEA may destabilise the composition through depletion flocculation. By using the fatty complexing material to complex with the mono-ester linked component, depletion flocculation is significantly reduced.

In other words, the fatty complexing agent at the increased levels, as required by the present invention, “neutralises” the mono-ester linked component of the quaternary ammonium material. This in situ di-ester generation from mono-ester and fatty alcohol also improves the softening of the composition.

Preferred fatty acids include tallow fatty acid or vegetable fatty acids, particularly preferred are hardened tallow fatty acid or hardened vegetable fatty acid (available under the trade name Pristerene™, ex Croda). Preferred fatty alcohols include tallow alcohol or vegetable alcohol, particularly preferred are hardened tallow alcohol or hardened vegetable alcohol (available under the trade names Stenol™ and Hydrenol™, ex BASF and Laurex™ CS, ex Huntsman). The fatty complexing agent is preferably present in an amount greater than 0.3 to 5% by weight based on the total weight of the composition. More preferably, the fatty component is present in an amount of from 0.4 to 4%. The weight ratio of the mono-ester component of the quaternary ammonium fabric softening material to the fatty complexing agent is preferably from 5:1 to 1:5, more preferably 4:1 to 1:4, most preferably 3:1 to 1:3, e.g., 2:1 to 1:2.

### Non-Ionic Surfactants

The fabric conditioners for use in the of the present invention preferably comprise nonionic surfactant. Typically, these can be included for the purpose of stabilising the compositions. Suitable nonionic surfactants include addition products of ethylene oxide and/or propylene oxide with fatty alcohols, fatty acids and fatty amines. Any of the alkoxylated materials of the particular type described hereinafter can be used as the nonionic surfactant.

Suitable surfactants are substantially water-soluble surfactants of the general formula (X):

R—Y—(C2H4O)z-CH2-CH2-OH (X)

where R is selected from the group consisting of primary, secondary and branched chain alkyl and/or acyl hydrocarbyl groups; primary, secondary and branched chain alkenyl hydrocarbyl groups; and primary, secondary and branched chain alkenyl-substituted phenolic hydrocarbyl groups; the hydrocarbyl groups having a chain length of from 8 to about 25, preferably 10 to 20, e.g., 14 to 18 carbon atoms.

In the general formula for the ethoxylated nonionic surfactant, Y is typically:
—O—, —C(O)O—, —C(O)N(R)— or —C(O)N(R)R—

in which R has the meaning given above for formula (X) or can be hydrogen; and Z is at least about 8, preferably at least about 10 or 11.

Preferably the nonionic surfactant has an HLB of from about 7 to about 20, more preferably from 10 to 18, e.g., 12 to 16. Genapol™ C200 (Clariant) based on coco chain and 20 EO groups is an example of a suitable nonionic surfactant.

If present, the nonionic surfactant is present in an amount from 0.01 to 10%, more preferably 0.1 to 5 by weight, based on the total weight of the composition.

A class of preferred non-ionic surfactants include addition products of ethylene oxide and/or propylene oxide with fatty alcohols, fatty acids and fatty amines. These are preferably selected from addition products of (a) an alkoxide selected from ethylene oxide, propylene oxide and mixtures thereof with (b) a fatty material selected from fatty alcohols, fatty acids and fatty amines.

Suitable surfactants are substantially water-soluble surfactants of the general formula (XI):

R—Y—(C2H4O)z-CH2-CH2-OH (XI)

where R is selected from the group consisting of primary, secondary and branched chain alkyl and/or acyl hydrocarbyl groups (when Y=—C(O)O, R≠an acyl hydrocarbyl group); primary, secondary and branched chain alkenyl hydrocarbyl groups; and primary, secondary and branched chain alkenyl-substituted phenolic hydrocarbyl groups; the hydrocarbyl groups having a chain length of from 10 to 60, preferably 10 to 25, e.g., 14 to 20 carbon atoms.

In the general formula for the ethoxylated nonionic surfactant, Y is typically:
—O—, —C(O)O—, —C(O)N(R)— or —C(O)N(R)R—

in which R has the meaning given above for formula (XI) or can be hydrogen; and Z is at least about 6, preferably at least about 10 or 11.

Lutensol™ AT25 (BASF) based on C16:18 chain and 25 EO groups is an example of a suitable non-ionic surfactant. Other suitable surfactants include Renex 36 (Trideceth-6), ex Croda; Tergitol 15-S3, ex Dow Chemical Co.; Dihydrol LT7, ex Thai Ethoxylate ltd; Cremophor C040, ex BASF and Neodol 91-8, ex Shell.

### Preservatives

The fabric conditioners for use in the method of the present invention preferably comprise preservatives, either a single preservative or a combination of preservatives. The level of preservatives is important to ensure preservation both before and after dilution of the concentrated formulations. Two preferred classes of preservatives are organic acid and/or the salts thereof and isothiazolinones. Examples of organic acid and/or the salts thereof are potassium sorbate and sodium benzoate. Examples of isothiazolinones are Methylisothiazolinone (MIT), Chloromethylisothiazolinone (CMIT) and Benzisothiazolinone (BIT). Generally, preservatives are preferably included at an inclusion level of 0.005 to 1 wt. %, more preferably 0.01 to 0.8 wt. %. Preferred inclusion levels of organic acid and/or the salts thereof are 0.05 to 0.8 wt. % and preferred inclusion levels of isothiazolinones is 0.01 to 0.05 wt. %.

### Other Ingredients

The fabric conditioners for use in the method of the present invention may comprise additional ingredients, as will be known to the person skilled in the art. Among such materials there may be mentioned: thickening polymers, antifoams, insect repellents, shading or hueing dyes, preservatives (e.g., bactericides), pH buffering agents, perfume carriers, hydrotropes, anti-redeposition agents, polyelectrolytes, anti-shrinking agents, anti-wrinkle agents, antioxidants, dyes, colorants, sunscreens, anti-corrosion agents, drape imparting agents, anti-static agents, sequestrants and ironing aids. The products of the invention may contain pearlisers and/or opacifiers. A preferred sequestrant is HEDP, an abbreviation for Etidronic acid or 1-hydroxyethane 1,1-diphosphonic acid.

The fabric conditioner composition is preferably in an aqueous form. The compositions preferably comprise at least 75 wt. % water.

### Preparation

The fabric conditioner compositions for use in the method described herein may be prepared via any suitable method. However, to maximise stability, preferably the fabric softening active and natural oil are pre-mixed prior to addition to water. Preferably the pre-mixing is performed at a temperature above 50° C., more preferably above 60° C. Once premixed, the ester oil and fabric softening active may be mixed with water.

In use

Described herein is a method of treating polyester during the laundry process, wherein a fabric conditioner composition comprising:
c 2 to 30 wt. % quaternary ammonium compound; and
d Natural oil;

is added to the rinse stage of the laundry process.

Preferably the method is a method of improving the speed of polyester drying time following the application of a fabric conditioner composition during a laundry process, wherein a fabric conditioner composition comprising:
a 2 to 30 wt. % quaternary ammonium compound; and
b Natural oil;

is added to the rinse stage of the laundry process.

The method of the present invention is used to soften polyesters.

Preferably the method is used to improve the speed of polyester drying time following the application of a fabric conditioner. Alternatively the method is preferably used to improve the deposition of a quaternary ammonium on polyester.

### Examples

TABLE 1
Example compositions

| | wt. % inclusion |
|---|---|
| | 1 |
| Fabric Softening active¹ | 6.5 |
| Natural oil: Pentaerythritol | 0.5 |
| Tetrastearate² | |
| Perfume | 0.7 |
| Perfume microcapsule | 0.4 |
| Mirrors; antifoam, dyes, pH | <1 |
| regulators, preservatives etc. | |
| water | To 100 |

TABLE 2
Compositions

wt. % inclusion

| Ingredients | A | 2 |
|---|---|---|
| Fabric Softening active¹ | 6 | 6 |
| Cetearyl Alcohol | 0.5 | 0.5 |
| Natural oil: Pentaerythritol | 0 | 1 |
| Tetrastearate² | | |
| Water | To 100 | To 100 |

The compositions were prepared by pre-melting the fabric softening active and cetearyl alcohol at ˜65° C. The pre-melt was then dispersed in the water. The natural oil was post dosed into the formulation 1. Fabric Softening active¹—TEA quaternary ammonium compound according to formula (I) aboveNatural oil: Pentaerythritol Tetrastearate²—Priolube 3987 ex. CrodaFilm forming polymer: hydrolysed protein³—Coltide radiance ex. CrodaFabric Softening active¹—TEA quaternary ammonium compoundNatural oil: Pentaerythritol Tetrastearate²—Priolube 3987 ex. Croda

2×20×20 cm pieces of polyester fabrics were washed with 0.29 g of the composition in 100 ml water. These were then dried and pieces were punched out and placed into aluminium trays approximately 0.33 mm radius. To these pieces 15 ul of water was added and then the trays sealed. The trays were then added to the Thermogravimetric Analyzer (TGA/DSC 1 ex. METTLER Toledo). Cycle was set for 50° C. for 40 mins to give a constant dry. The gradient of each the rate of drying line was then calculated. The more negative the number, the faster the drying time.

TABLE 3
Results

| Composition | Rate of drying slope |
|---|---|
| A | −0.000302 |
| 2 | −0.000570 |

The fabrics treated with a fabric conditioner comprising natural oil (composition 1) have a faster drying time than those treated with composition A.

1. A method of treating polyester during a laundry process, wherein a fabric conditioner composition comprising:
a 2 to 30 wt. % quaternary ammonium compound; and
b natural oil;
is added to a rinse stage of the laundry process, and wherein the natural oil comprises plant oils or esterified fatty acids of plant oils.

2. The method according to claim 1, wherein the natural oil comprises seed oils or the esterified fatty acids thereof.

3. The method according to claim 1, wherein the natural oil is selected from triglycerides and ester oils.

4. The method according to claim 1, wherein the composition comprises 0.25 wt. % to 15 wt. % natural oil.

5. The method according to claim 1, wherein the fabric softening active in the composition is an ester linked quaternary ammonium compound.

6. The method according to claim 1, wherein the composition further comprises perfume microcapsules.

7. The method according to claim 5 wherein the fabric softening active and natural oil are pre-mixed prior to addition to water.

8. The method according to claim 1, wherein the treated polyester has an improved drying time following application of the fabric conditioner.
